(19) United States
(12) Patent Application Publication
(10) Pub. No.: US 2013/0193791 A1
(43) Pub. Date: Aug. 1, 2013

(54) BEARING ASSEMBLY AND SPINDLE MOTOR INCLUDING THE SAME

(71) Applicants: Han Byul Kim, Suwon (KR); Ik Sun Lee, Suwon (KR); Ju Ho Kim, Suwon (KR)

(72) Inventors: Han Byul Kim, Suwon (KR); Ik Sun Lee, Suwon (KR); Ju Ho Kim, Suwon (KR)

(73) Assignee: SAMSUNG ELECTRO-MECHANICS CO., LTD., Suwon (KR)

(21) Appl. No.: 13/439,443

(22) Filed: Apr. 4, 2012

(30) Foreign Application Priority Data
Jan. 27, 2012 (KR) 10-2012-0008059

(51) Int. Cl. F16C 32/06; H02K 7/08

(52) U.S. Cl. 310/90; 384/114

(57) ABSTRACT

There is provided a bearing assembly including: a sleeve supporting a shaft via oil; a sleeve supporting a shaft via oil; a sleeve housing surrounding the sleeve to prevent leakage of the oil; and at least one circulation part formed such that upper and lower surfaces of at least one of the sleeve and the sleeve housing are in communication with each other, wherein at least one of an outer peripheral surface of the sleeve and an inner peripheral surface of the sleeve housing has a maximum radius of curvature at a portion adjacent to the circulation part.

### CROSS-REFERENCE TO RELATED APPLICATIONS

This application claims the priority of Korean Patent Application No. 10-2012-0008059 filed on Jan. 27, 2012, in the Korean Intellectual Property Office, the disclosure of which is incorporated herein by reference.

### BACKGROUND OF THE INVENTION

1. Field of the Invention

The present invention relates to a bearing assembly and a spindle motor including the same, and more particularly, to a motor capable of being used in a hard disk drive (HDD) for rotating a recording disk.

2. Description of the Related Art

A hard disk drive (HDD), an information storage device, reads data stored on a disk or writes data to a disk using a read/write head.

The hard disk drive requires a disk driving device capable of driving the disk. In the disk driving device, a small-sized spindle motor is used.

In the small-sized spindle motor, a fluid dynamic bearing has been used. The fluid dynamic bearing is a bearing in which a shaft, a rotating member, and a sleeve, a fixed member, include oil interposed therebetween, such that rotation of the shaft is supported by fluid pressure generated in the oil.

Here, as the sleeve used in the small-sized spindle motor, there may be provided a sintered sleeve and a processed sleeve. To allow the spindle motor to be competitively priced, a sintered sleeve having a high oil content has been mainly used.

Meanwhile, the spindle motor using the sintered sleeve may have a large oil content, such that a variation of an oil interface due to thermal expansion of the oil increase. Therefore, the spindle motor using the sintered sleeve having a high oil content requires a sleeve housing surrounding the sleeve in order to prevent the leakage of oil.

The sleeve housing and the sleeve have been coupled to each other by sliding or press-fitting the sleeve into the sleeve housing and bonding the sleeve and the sleeve housing to each other with an adhesive. However, in this process, the adhesive may be introduced into a circulation hole for controlling pressure to thereby deteriorate a function of the circulation hole.

As a result, a predetermined region of the circulation hole is blocked by the adhesive to cause a defect in functions of adjusting internal pressure of the spindle motor and discharging air bubbles, thereby deteriorating performance and a lifespan of the spindle motor.

Therefore, research into a technology of preventing an adhesive from being introduced into a circulation hole at the time of coupling a sleeve and a sleeve housing to each other to significantly increase spindle motor performance and lifespan has been urgently demanded.

According to Patent Document 1, mentioned in the following Related Art Document, there is still a problem in that, in the case of coupling a sleeve and a sleeve housing to each other with an adhesive, the adhesive may be introduced into a circulation hole to thereby deteriorate a function of the circulation hole.

### RELATED ART DOCUMENT

(Patent Document 1) Korean Patent Laid-open Publication No. 2010-0069199

### SUMMARY OF THE INVENTION

An aspect of the present invention provides a bearing assembly capable of preventing a function of a circulation part from being deteriorated in advance by preventing an adhesive from being introduced into the circulation part in the case of coupling a sleeve and a sleeve housing to each other, and a spindle motor including the same.

According to an aspect of the present invention, there is provided a bearing assembly including: a sleeve supporting a shaft via oil; a sleeve housing surrounding the sleeve to prevent leakage of the oil; and at least one circulation part formed such that upper and lower surfaces of at least one of the sleeve and the sleeve housing are in communication with each other, wherein at least one of an outer peripheral surface of the sleeve and an inner peripheral surface of the sleeve housing has a maximum radius of curvature at a portion adjacent to the circulation part.

The at least one circulation part may be formed by being depressed from the outer peripheral surface of the sleeve, and the outer peripheral surface of the sleeve may have the maximum radius of curvature at the portion adjacent to the circulation part.

The at least one circulation part may be formed by being depressed from the outer peripheral surface of the sleeve, and the inner peripheral surface of the sleeve housing may have a radius of curvature, larger at a portion corresponding to a boundary between the circulation part and an outer side of the circulation part, than at a portion corresponding to the outer side of the circulation part.

The at least one circulation part may be formed by being depressed from the inner peripheral surface of the sleeve housing, and the inner peripheral surface of the sleeve housing may the maximum radius of curvature at the portion adjacent to the circulation part.

The at least one circulation part may be formed by being depressed from the inner peripheral surface of the sleeve housing, and the outer peripheral surface of the sleeve may have a radius of curvature, larger at a portion corresponding to a boundary between the circulation part and an outer side of the circulation part, than at a portion corresponding to the outer side of the circulation part.

The at least one circulation part may include at least one first communication part and at least one second communication part formed to face each other, the at least one first communication part being depressed from the outer peripheral surface of the sleeve such that the upper and lower surfaces of the sleeve are in communication with each other and the at least one second communication part being depressed from the inner peripheral surface of the sleeve housing such that the upper and lower surfaces of the sleeve housing are in communication with each other, and the at least one of the outer peripheral surface of the sleeve and the inner peripheral surface of the sleeve housing may have the maximum radius of curvature at the portion adjacent to the circulation part.

The at least one of the outer peripheral surface of the sleeve and the inner peripheral surface of the sleeve housing may have a radius of curvature gradually increasing toward the circulation part.

The circulation part may be symmetrical based on a center of rotation of the shaft.

According to another aspect of the present invention, there is provided a bearing assembly including: a sleeve supporting a shaft via oil; a sleeve housing surrounding the sleeve to prevent leakage of the oil; and at least one circulation part formed such that upper and lower surfaces of at least one of the sleeve and the sleeve housing are in communication with each other, wherein a space filled by an adhesive provided between the sleeve and the sleeve housing is maximal at a portion adjacent to the circulation part.

The space filled by the adhesive provided between the sleeve and the sleeve housing may gradually increase toward the circulation part.

Predetermined regions of an outer peripheral surface of the sleeve and an inner peripheral surface of the sleeve housing may be in contact with each other by press-fitting.

According to another aspect of the present invention, there is provided a spindle motor including: the bearing assembly as described above; a hub rotating together with the shaft and having a magnet coupled thereto; and a base coupled to the sleeve housing and including a core having a coil wound therearound, the coil generating rotational driving force.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor including a bearing assembly according to a first embodiment of the present invention;

FIG. 2 is a schematic cut-away, exploded perspective view showing the bearing assembly according to the first embodiment of the present invention;

FIG. 3 is a schematic perspective view showing a sleeve and a sleeve housing provided in the bearing assembly according to the first embodiment of the present invention;

FIG. 4 is a schematic plan view showing the sleeve and the sleeve housing provided in the bearing assembly according to the first embodiment of the present invention;

FIG. 5 is a schematic plan view showing a sleeve and a sleeve housing provided in a bearing assembly according to a second embodiment of the present invention;

FIG. 6 is a schematic plan view showing a sleeve and a sleeve housing provided in a bearing assembly according to a third embodiment of the present invention;

FIG. 7 is a schematic plan view showing a sleeve and a sleeve housing provided in a bearing assembly according to a fourth embodiment of the present invention;

FIG. 8 is a schematic plan view showing a sleeve and a sleeve housing provided in a bearing assembly according to a fifth embodiment of the present invention;

FIG. 9 is a schematic plan view showing a sleeve and a sleeve housing provided in a bearing assembly according to a sixth embodiment of the present invention; and

FIG. 10 is a schematic plan view showing a sleeve and a sleeve housing provided in a bearing assembly according to a seventh embodiment of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and that those skilled in the art and understanding the present invention could easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings within the scope of the present invention.

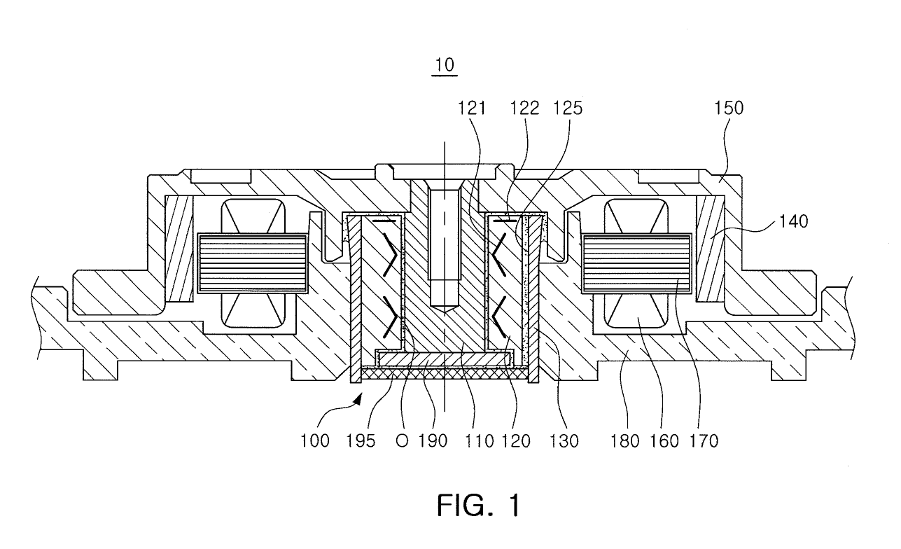

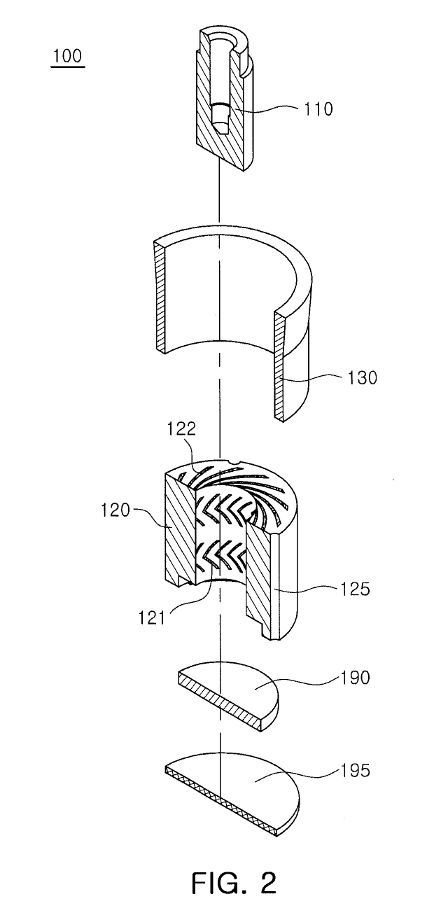

FIG. 1 is a schematic cross-sectional view showing a spindle motor including a bearing assembly according to a first embodiment of the present invention; and FIG. 2 is a schematic cut-away exploded perspective view showing the bearing assembly according to the first embodiment of the present invention.

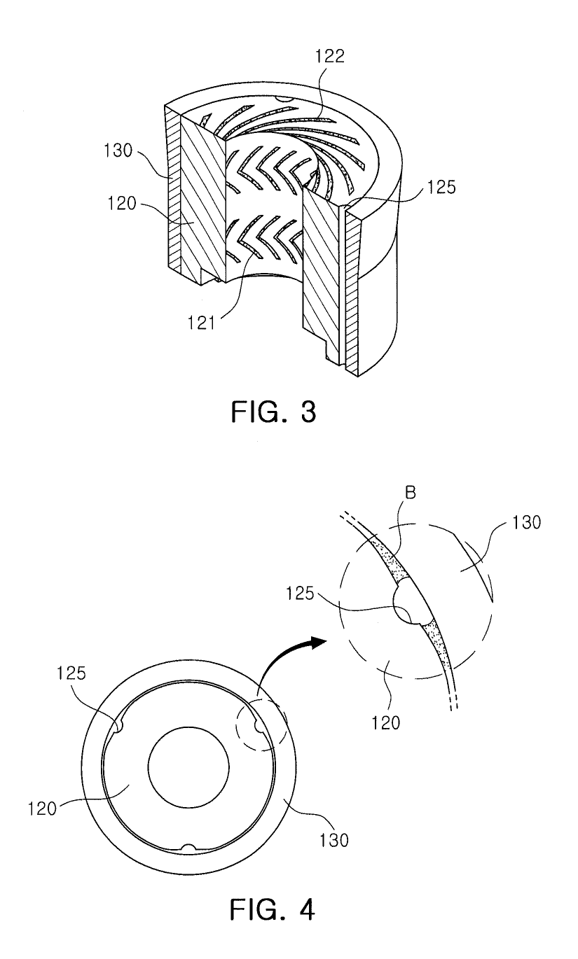

In addition, FIG. 3 is a schematic perspective view showing a sleeve and a sleeve housing provided in the bearing assembly according to the first embodiment of the present invention; and FIG. 4 is a schematic plan view showing the sleeve and the sleeve housing provided in the bearing assembly according to the first embodiment of the present invention.

Referring to FIGS. 1 through 4, a spindle motor 10 including a bearing assembly 100 according to the first embodiment of the present invention may include the bearing assembly 100 including a sleeve 120 and a sleeve housing 130, a hub 150 having a magnet 140 coupled thereto, and a base 180 including a core 170 having a coil 160 wound therearound.

Terms with respect to directions will be first defined. As viewed in FIG. 1, an axial direction refers to a vertical direction based on the shaft 110, and an outer diameter or inner diameter direction refers to a direction towards an outer edge of a hub 150 based on the shaft 110 or a direction towards a center of the shaft 110 based on the outer edge of the hub 150.

The bearing assembly 100 may include the sleeve 120 supporting the shaft 110 and the sleeve housing 130 surrounding the sleeve 120, wherein at least one of the sleeve 120 and the sleeve housing 130 may include at least one circulation part 125.

The sleeve 120 is a component supporting the shaft 110 which is a component of the rotating member. The sleeve 120 may support the shaft 110 such that an upper end of the shaft 110 is protruded upwardly in the axial direction and be formed by sintering a Cu—Fe based alloy powder or a SUS based power.

Therefore, the sleeve 120 may be a sintered sleeve and have oil O (to be described later) impregnated therein to significantly increase a content of the oil O provided to the bearing assembly 100.

In addition, the sleeve 120 may include a shaft hole having the shaft 110 inserted thereinto so as to have a micro clearance therebetween, wherein the micro clearance may be filled with the oil O to stably support the shaft 110 by radial dynamic pressure via the oil O.

Here, the radial dynamic pressure via the oil O may be generated by a fluid dynamic pressure part 121 formed in at least one of an inner peripheral surface of the sleeve 120 and an outer peripheral surface of the shaft 110. The fluid dynamic pressure part 121 may have one of a herringbone shape, a spiral shape, a screw shape.

However, the fluid dynamic pressure part 121 is not limited to being formed in the inner peripheral surface of the sleeve 120 as described above, but may also be formed in the outer peripheral surface of the shaft 110. In addition, the number of fluid dynamic pressure parts 121 is also not limited.

In addition, the sleeve 120 may include a thrust dynamic pressure part 122 formed on an upper surface thereof so as to generate thrust dynamic pressure via the oil O. The rotating member including the shaft 110 may rotate in a state in which a predetermined floating force is secured by the thrust dynamic pressure part 122.

Here, the thrust dynamic pressure part 122 may be a groove having a herringbone shape, a spiral shape, or a screw shape, similar to the fluid dynamic pressure part 121. However, the thrust dynamic pressure part 122 is not necessarily limited to having the above-mentioned shape, but may have any shape as long as the thrust dynamic pressure may be provided.

In addition, the thrust dynamic pressure part 122 is not limited to being formed in the upper surface of the sleeve 120, but may also be formed in one surface of the hub 150 corresponding to the upper surface of the sleeve 120.

Meanwhile, the shaft 110 may include a stopper 190 provided at a lower portion thereof in order to prevent the shaft 110 from being excessively floated at the time of rotation thereof.

Here, the stopper 190 may be separately manufactured and then coupled to the shaft 110. However, the stopper 140 may be formed integrally with the shaft 110 at the time of manufacturing thereof and may rotate together with the shaft 110 at the time of the rotation of the shaft 110.

The stopper 190 may have an outer side portion contacting a lower surface of the sleeve 120 in the case in which the rotating member including the shaft 110 is excessively floated, thereby preventing the rotating member from being excessively floated.

Here, the sleeve 120 may include the at least one circulation part 125, wherein the circulation part 125 may be formed by being depressed from an outer peripheral surface of the sleeve 120 such that upper and lower surfaces of the sleeve 120 are in communication with each other.

In addition, the circulation part 125 may be symmetrical, based on the center of rotation of the shaft 110.

Here, the circulation part 125 may become a circulation hole after the sleeve 120 and the sleeve housing 130 are bonded to each other by an adhesive B to circulate the oil O provided to the bearing assembly 100 and at the same time to disperse pressure of the oil O, thereby maintaining balance of the pressure.

In addition, the circulation part 125 may serve as a discharge path allowing air bubbles, or the like, capable of being generated in an inner portion of the bearing assembly 100 to be discharged by circulation.

Therefore, the circulation part 125 needs to be normally maintained even after the sleeve 120 and the sleeve housing 130 are coupled to each other. Particularly, the introduction of the adhesive B for coupling the sleeve 120 and the sleeve housing 130 to each other, into the circulation part 125, needs to be completely blocked.

A detailed description thereof will be provided after a description of the sleeve housing 130 is provided.

The sleeve housing 130 may surround the sleeve 120 described above to prevent the leakage of the oil O impregnated in the sleeve 120 and may be coupled to the sleeve 120 by a bonding method through the adhesive B.

More specifically, the sleeve housing 130 may be coupled to the outer peripheral surface of the sleeve 120 containing the oil O to prevent the leakage of the oil O and allow the circulation part 125 formed in the sleeve 120 to be implemented as a circulation hole.

Here, the adhesive B for coupling the sleeve 120 and the sleeve housing 130 should not be introduced into the circulation part 125 in order for the circulation part 125 to perform its original function. To this end, the outer peripheral surface of the sleeve 120 may have a maximum radius of curvature at a portion adjacent to the circulation part 125.

In other words, the radius of curvature of the outer peripheral surface of the sleeve 120 may gradually increase toward the circulation part 125. Therefore, a space filled by the adhesive B provided between the sleeve 120 and the sleeve housing 130 may be maximal at the portion adjacent to the circulation part 125.

Accordingly, the space filled by the adhesive B provided between the sleeve 120 and the sleeve housing 130 may gradually increase toward the circulation part 125.

Therefore, the space filled by the adhesive B between the sleeve 120 and the sleeve housing 130 in order to couple the sleeve 120 and the sleeve housing 130 to each other increases toward the circulation part 125, such that the adhesive B may not arrive at the circulation part 125.

This may be considered as a result due to a capillary phenomenon and prevent the adhesive B from being introduced into the circulation part 125 in advance to prevent an original function of the circulation part 125 from being deteriorated.

Meanwhile, the sleeve housing 130 may include a base cover 195 coupled to a lower portion thereof so as to close the lower portion of the sleeve 120.

The base cover 195 may receive the oil O in a clearance between the sleeve 120 and the stopper 190 to serve as a bearing supporting rotation of the shaft 110 and the stopper 190.

In addition, since the oil O may be successively filled in the clearance between the shaft 110 and the sleeve 120, a clearance between the hub 150 and the sleeve 120, and a clearance between the base cover 195 and the stopper 190, the spindle motor 10 according to the present invention may be entirely formed to have a full-fill structure.

The hub 150 may be a rotating structure rotatably provided with respect to a fixed member including the base 180.

In addition, the hub 150 may include an annular ring shaped magnet 140 provided on an inner peripheral surface thereof, wherein the annular ring shaped magnet 140 corresponds to the core 170, while having a predetermined interval therewith.

Here, the magnet 140 interacts with the coil 160 wound around the core 170, whereby the spindle motor 10 according to the embodiment of the present invention may obtain rotational driving force.

The base 180 may be a component of the fixed member supporting rotation of the rotating member including the shaft 110 and the hub 150 with respect to the rotating member.

Here, the base 180 may include the core 170 coupled thereto, wherein the core 170 has the coil 160 wound therearound. The core 170 may be fixedly disposed on an upper portion of the base 180 including a printed circuit board (not shown) having pattern circuits printed thereon.

In other words, an outer peripheral surface of the sleeve housing 130 and the core 170 around which the coil 160 is wound are inserted into the base 180, such that the sleeve housing 130 and the core 170 may be coupled thereto.

Here, as a method of coupling the sleeve housing 130 and the core 170 to the base 180, a bonding method, a welding method, a press-fitting method, or the like, may be used. However, a method of coupling the sleeve housing 130 and the core 170 to the base 180 is not necessarily limited thereto.

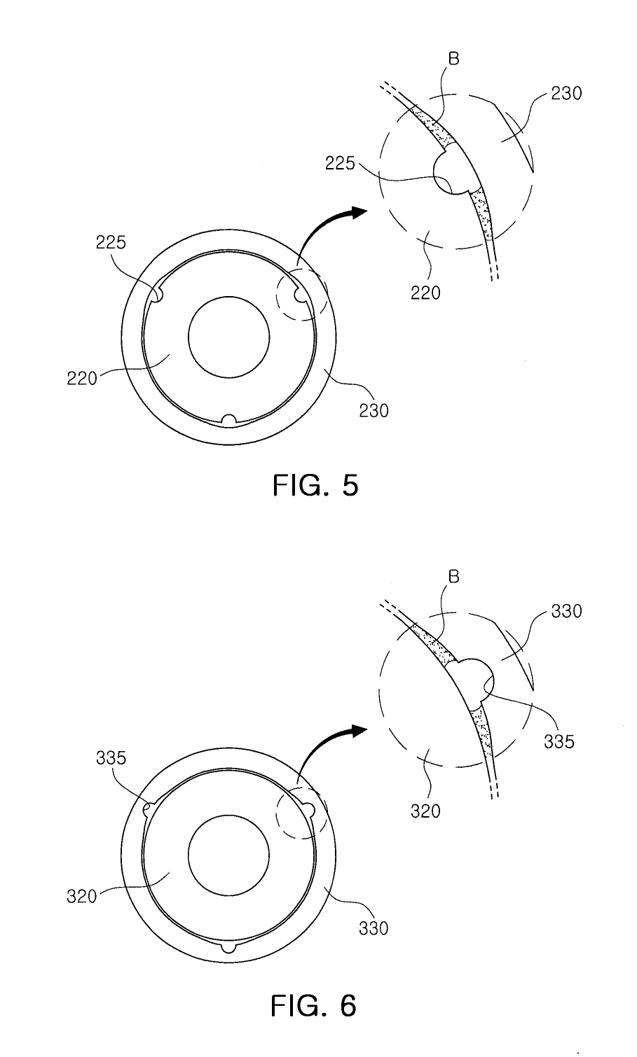

FIG. 5 is a schematic plan view showing a sleeve and a sleeve housing provided in a bearing assembly according to a second embodiment of the present invention.

Referring to FIG. 5, a sleeve 220 provided in the bearing assembly according to the second embodiment of the present invention may include at least one circulation part 225, which may have the same configuration and effect as those of the circulation part 125 described with reference to FIGS. 1 through 4.

Here, an inner peripheral surface of a sleeve housing 230 may have a variable radius of curvature. More specifically, the inner peripheral surface of the sleeve housing 230 may have a radius of curvature larger at a portion corresponding to a boundary between the circulation part 225 and an outer side of the circulation part 225, than at a portion corresponding to the outer side of the circulation part 225.

In other words, the radius of curvature of the inner peripheral surface of the sleeve housing 230 may gradually increase toward the circulation part 225. Therefore, a space filled by the adhesive B provided between the sleeve 220 and the sleeve housing 230 may gradually increase toward the circulation part 225 to be maximal at a portion adjacent to the circulation part 225.

Therefore, the space filled by the adhesive B between the sleeve 220 and the sleeve housing 230 in order to couple the sleeve 220 and the sleeve housing 230 to each other increases toward the circulation part 225, such that the adhesive B may not arrive at the circulation part 225.

FIG. 6 is a schematic plan view showing a sleeve and a sleeve housing provided in a bearing assembly according to a third embodiment of the present invention.

Referring to FIG. 6, a sleeve housing 330 provided in the bearing assembly according to the third embodiment of the present invention may include at least one circulation part 335, which may be formed by being depressed from an inner peripheral surface of the sleeve housing 330 such that upper and lower surfaces of the sleeve housing 330 are in communication with each other.

Here, the circulation part 335 may be symmetrical based on the center of rotation of the shaft 110 and serve as a circulation hole after the sleeve housing 330 and a sleeve 320 are coupled to each other.

Meanwhile, the inner peripheral surface of the sleeve housing 330 may have a maximum radius of curvature at a portion adjacent to the circulation part 335 and gradually increase toward the circulation part 335.

Therefore, a space filled by the adhesive B provided between the sleeve 320 and the sleeve housing 330 may gradually increase toward the circulation part 335 to be maximal at a portion adjacent to the circulation part 335.

Therefore, the space filled by the adhesive B filled between the sleeve 320 and the sleeve housing 330 in order to couple the sleeve 320 and the sleeve housing 330 to each other increases toward the circulation part 335, such that the adhesive B may not arrive at the circulation part 335.

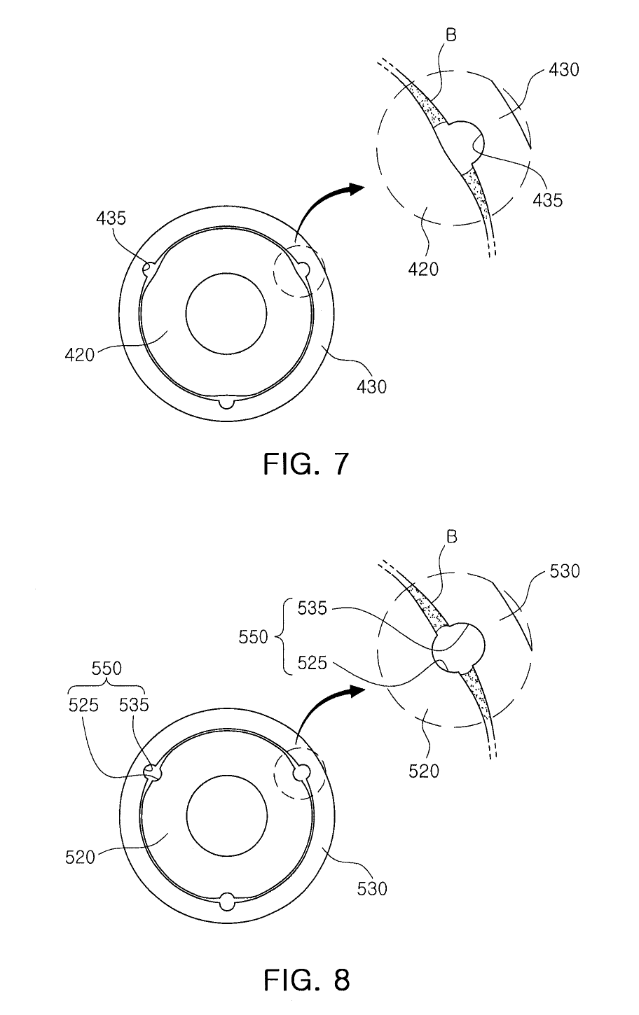

FIG. 7 is a schematic plan view showing a sleeve and a sleeve housing provided in a bearing assembly according to a fourth embodiment of the present invention.

Referring to FIG. 7, a sleeve housing 430 provided in the bearing assembly according to the fourth embodiment of the present invention may include at least one circulation part 435, which may have the same configuration and effect as those of the circulation part 335 described with reference to FIG. 6.

Here, an outer peripheral surface of a sleeve 420 may have a variable radius of curvature. More specifically, the radius of curvature of the sleeve 420 maybe larger at a portion corresponding to a boundary between the circulation part 435 and an outer side of the circulation part 435 than at a portion corresponding to the outer side of the circulation part 435.

In other words, the radius of curvature of the outer peripheral surface of the sleeve 420 may gradually increase toward the circulation part 435. Therefore, a space filled by the adhesive B provided between the sleeve 420 and the sleeve housing 430 may gradually increase toward the circulation part 435 to be maximal at a portion adjacent to the circulation part 435.

Therefore, the space filled by the adhesive B between the sleeve 420 and the sleeve housing 430 in order to couple the sleeve 420 and the sleeve housing 430 to each other increases toward the circulation part 435, such that the adhesive B may not arrive at the circulation part 435.

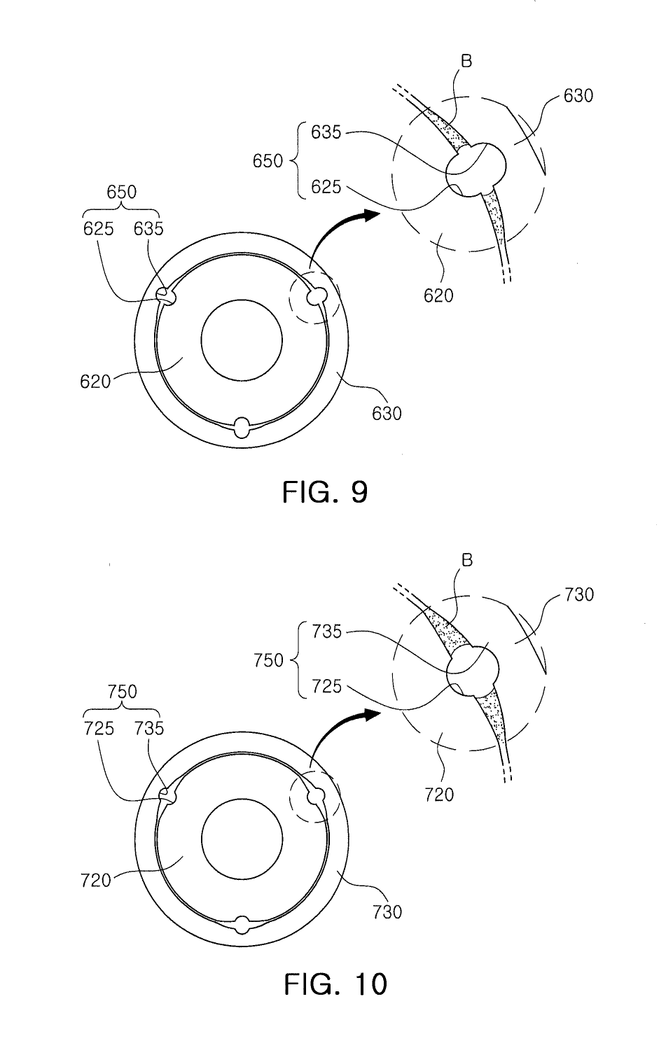

FIG. 8 is a schematic plan view showing a sleeve and a sleeve housing provided in a bearing assembly according to a fifth embodiment of the present invention; FIG. 9 is a schematic plan view showing a sleeve and a sleeve housing provided in a bearing assembly according to a sixth embodiment of the present invention; and FIG. 10 is a schematic plan view showing a sleeve and a sleeve housing provided in a bearing assembly according to a seventh embodiment of the present invention.

Referring to FIGS. 8 through 10, each of the bearing assemblies according to the fifth to seventh embodiments of the present invention may include at least one first communication part 525, 625, or 725 and at least one second communication part 535, 635, or 735 each formed in a sleeve 520, 620, or 720 and a sleeve housing 530, 630, or 730 in order to implement a circulation part 550, 650, or 750.

The at least one first communication part 525, 625, or 725 may be formed by being depressed from an outer peripheral surface of the sleeve 520, 620, or 720 such that upper and lower surfaces of the sleeve 520, 620, or 720 are in communication with each other, and the at least one second communication part 535, 635, or 735 may be formed by being depressed from an inner peripheral surface of the sleeve housing 530, 630, or 730 such that upper and lower surfaces of the sleeve housing 530, 630, or 730 are in communication with each other.

Here, the first communication part 525, 625, or 725 and the second communication part 535, 635, or 735 may be disposed to face each other. Therefore, the first communication part 525, 625, or 725 and the second communication part 535, 635, or 735 may allow the circulation part 550, 650, or 750 to be implemented after the sleeve 520, 620, or 720 and the sleeve housing 530, 630, or 730 are bonded to each other by an adhesive B.

Here, the circulation part 550, 650, or 750 may be symmetrical based on the center of rotation of the shaft 110.

Meanwhile, a space filled by the adhesive B provided between the sleeve 520, 620, or 720 and the sleeve housing 530, 630, or 730 may gradually increase toward the circulation part 550, 650, or 750 to be maximal at a portion adjacent to the circulation part 550, 650, or 750.

More specifically, referring to FIG. 8, a radius of curvature of an outer peripheral surface of the sleeve 520 may gradually increase toward the circulation part 550 to be maximal at a portion adjacent to the circulation part 550.

In addition, referring to FIG. 9, a radius of curvature of an inner peripheral surface of the sleeve housing 630 may gradually increase toward the circulation part 650 to be maximal at a portion adjacent to the circulation part 650.

In addition, referring to FIG. 10, a radius of curvature of an outer peripheral surface of the sleeve 720 may gradually increase toward the circulation part 750 to be maximal at a portion adjacent to the circulation part 750, and a radius of curvature of an inner peripheral surface of the sleeve housing 730 may gradually increase toward the circulation part 750 to be maximal at a portion adjacent to the circulation part 750.

Additionally, although the embodiments in which the sleeves 120 to 720 and the sleeve housing 130 to 730 are coupled to each other by a bonding method using the adhesive B have been described with reference to FIGS. 1 through 10, a method of coupling the sleeves 120 to 720 and the sleeve housing 130 to 730 to each other by press-fitting predetermined regions of outer peripheral surfaces of the sleeves 120 to 720 into predetermined regions of inner peripheral surfaces of the sleeve housing 130 to 730 may be simultaneously applied together with the bonding method using the adhesive B.

As set forth above, with the bearing assembly and the spindle motor including the same according to the embodiments of the present invention, deterioration in the function of the circulation part may be prevented in advance by blocking the adhesive for coupling the sleeve and the sleeve housing to each other from being introduced into the circulation part.

While the present invention has been shown and described in connection with the embodiments, it will be apparent to those skilled in the art that modifications and variations can be made without departing from the spirit and scope of the invention as defined by the appended claims.

What is claimed is:

1. A bearing assembly comprising:
a sleeve supporting a shaft via oil;
a sleeve housing surrounding the sleeve to prevent leakage of the oil; and
at least one circulation part formed such that upper and lower surfaces of at least one of the sleeve and the sleeve housing are in communication with each other,
wherein at least one of an outer peripheral surface of the sleeve and an inner peripheral surface of the sleeve housing has a maximum radius of curvature at a portion adjacent to the circulation part.

2. The bearing assembly of claim 1, wherein the at least one circulation part is formed by being depressed from the outer peripheral surface of the sleeve, and
the outer peripheral surface of the sleeve has the maximum radius of curvature at the portion adjacent to the circulation part.

3. The bearing assembly of claim 1, wherein the at least one circulation part is formed by being depressed from the outer peripheral surface of the sleeve, and
the inner peripheral surface of the sleeve housing has a radius of curvature, larger at a portion corresponding to a boundary between the circulation part and an outer side of the circulation part, than at a portion corresponding to the outer side of the circulation part.

4. The bearing assembly of claim 1, wherein the at least one circulation part is formed by being depressed from the inner peripheral surface of the sleeve housing, and
the inner peripheral surface of the sleeve housing the maximum radius of curvature at the portion adjacent to the circulation part.

5. The bearing assembly of claim 1, wherein the at least one circulation part is formed by being depressed from the inner peripheral surface of the sleeve housing, and
the outer peripheral surface of the sleeve has a radius of curvature, larger at a portion corresponding to a boundary between the circulation part and an outer side of the circulation part, than at a portion corresponding to the outer side of the circulation part.

6. The bearing assembly of claim 1, wherein the at least one circulation part includes at least one first communication part and at least one second communication part formed to face each other, the at least one first communication part being depressed from the outer peripheral surface of the sleeve such that the upper and lower surfaces of the sleeve are in communication with each other and the at least one second communication part being depressed from the inner peripheral surface of the sleeve housing such that the upper and lower surfaces of the sleeve housing are in communication with each other, and
the at least one of the outer peripheral surface of the sleeve and the inner peripheral surface of the sleeve housing has the maximum radius of curvature at the portion adjacent to the circulation part.

7. The bearing assembly of claim 1, wherein the at least one of the outer peripheral surface of the sleeve and the inner peripheral surface of the sleeve housing has a radius of curvature gradually increasing toward the circulation part.

8. The bearing assembly of claim 1, wherein the circulation part is symmetrical based on a center of rotation of the shaft.

9. A bearing assembly comprising:
a sleeve supporting a shaft via oil;
a sleeve housing surrounding the sleeve to prevent leakage of the oil; and
at least one circulation part formed such that upper and lower surfaces of at least one of the sleeve and the sleeve housing are in communication with each other,
wherein a space filled by an adhesive provided between the sleeve and the sleeve housing is maximal at a portion adjacent to the circulation part.

10. The bearing assembly of claim 9, wherein the space filled by the adhesive provided between the sleeve and the sleeve housing gradually increases toward the circulation part.

11. The bearing assembly of claim 9, wherein predetermined regions of an outer peripheral surface of the sleeve and an inner peripheral surface of the sleeve housing are in contact with each other by press-fitting.

12. A spindle motor comprising:
the bearing assembly according to claim 1;
a hub rotating together with the shaft and having a magnet coupled thereto; and
a base coupled to the sleeve housing and including a core having a coil wound therearound, the coil generating rotational driving force.
